(19) United States
(12) Patent Application Publication
(10) Pub. No.: US 2007/0078644 A1
(43) Pub. Date: Apr. 5, 2007

(54) Detecting segmentation errors in an annotated corpus

(75) Inventors: Chang-Ning Huang, Beijing (CN); Jianfeng Gao, Redmond, WA (US); Mu Li, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/241,037

(22) Filed: Sep. 30, 2005

(51) Int. Cl. G06F 17/27

(52) U.S. Cl. 704/9

(57) ABSTRACT

Segmentation error candidates are detected using segmentation variations found in an annotated corpus.

### BACKGROUND

The discussion below is merely provided for general background information and is not intended to be used as an aid in determining the scope of the claimed subject matter.

Word segmentation refers to the process of identifying the individual words that make up an expression of language, such as text. Word segmentation is useful for checking spelling and grammar, synthesizing speech from text, and performing natural language parsing and understanding, all of which benefit from an identification of individual words.

Performing word segmentation of English text is rather straightforward, since spaces and punctuation marks generally delimit the individual words in the text. Consider the English sentence below:

The motion was then tabled—that is, removed indefinitely from consideration.

By identifying each contiguous sequence of spaces and/or punctuation marks as the end of the word preceding the sequence, the English sentence above may be straightforwardly segmented below:

The motion was then tabled—that is, removed indefinitely from consideration.

In text such as but not limited to Chinese, word boundaries are implicit rather than explicit. Consider the Chinese sentence below, meaning “The committee discussed this problem yesterday afternoon in Buenos Aires.”

[symbol]

[symbol]

[symbol]

[symbol]

Despite the absence of punctuation and spaces from the sentence, a reader of Chinese would recognize the sentence above as being comprised of the words separately as underline:

[symbol]

[symbol]

[symbol]

[symbol]

Word segmentation systems have been advanced to automatically segment languages devoid of spaces and punctuation such as Chinese. In addition, many systems will also annotate the resulting segmented text to include information about the words in the sentence. The recognition and subsequent annotation of named entities in the text is common and useful. Named entities are typically important terms in sentences or phrases in that they comprise persons, places, amounts, dates and times to name just a few. However different systems will follow different specifications or rules when performing segmentation and annotation. For instance, one system may treat and then annotate a person's full name as a single named entity, while another may treat and thereby annotate the person's family name and given name as separate named entities. Although each system's output may considered correct, a comparison between the systems is difficult.

Recently, a methodology has been advanced to aid in making comparisons between different systems. Generally, the methodology includes having known training data and test data. The training data is used to train each system, while experiments can be run against the test data, the outputs of which: can then be compared in theory. A problem however has been found in that there exists inconsistencies between the training data and the test data. In view of these inconsistencies, an accurate comparison between systems can not be made, because the inconsistencies can propagate to the output of the system, giving a false error, i.e. an error that is not attributable to the system, but rather to the data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Segmented error candidates are detected using segmentation variations found in the annotated corpus. Detecting segmentation errors in a corpus ensures that the corpus is accurate and consistent so as to reduce the propagation of the errors to other systems. One method for locating segmentation errors in an annotated corpus can include obtaining sets of segmentation variation instances of multi-character words from the corpus with a computer. Each set comprises more than one segmentation variation instance of a word in the corpus. Each segmentation variation instance is rendered to a language analyzer with the computer to identify if the segmentation variation instance is a segmentation error.

In another aspect, a segmentation error rate of an annotated corpus can be calculated. In particular, the annotated corpus is processed with a computer to ascertain segmentation variations therein. The segmentation variations are then presented or rendered to a language analyzer with the computer to identify segmentation errors in the segmentation variations. A segmentation error rate for the corpus is then calculated based on the number of segmentation errors.

### BRIEF DESCRIPTION OF THE DRAWINGS

FIG. 1 is a block diagram of an exemplary embodiment of a computing environment.

FIG. 2 is a flow chart of a method for identifying segmentation errors in a corpus.

FIG. 3 is a more detailed flow chart of a method for identifying segmentation errors in a corpus or corpuses.

FIG. 4 is a block diagram of a system for performing the methods of FIG. 2 or 3.

### DETAILED DESCRIPTION

One aspect of the concepts herein described includes a method to detect inconsistencies between training and test data used in word segmentation such as in evaluation of word segmentation systems. However, before describing further aspects, it may be useful to describe generally an example of a suitable computing system environment 100 on which the concepts herein described may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

In addition to the examples herein provided, other well known computing systems, environments, and/or configurations may be suitable for use with concepts herein described. Such systems include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The concepts herein described may be embodied in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The concepts herein described may also be practiced in distributed computing environments where tasks are performed by remote processing devices that are linked through a communications network. In a distributed computing environment, program modules may be located in both locale and remote computer storage media including memory storage devices.

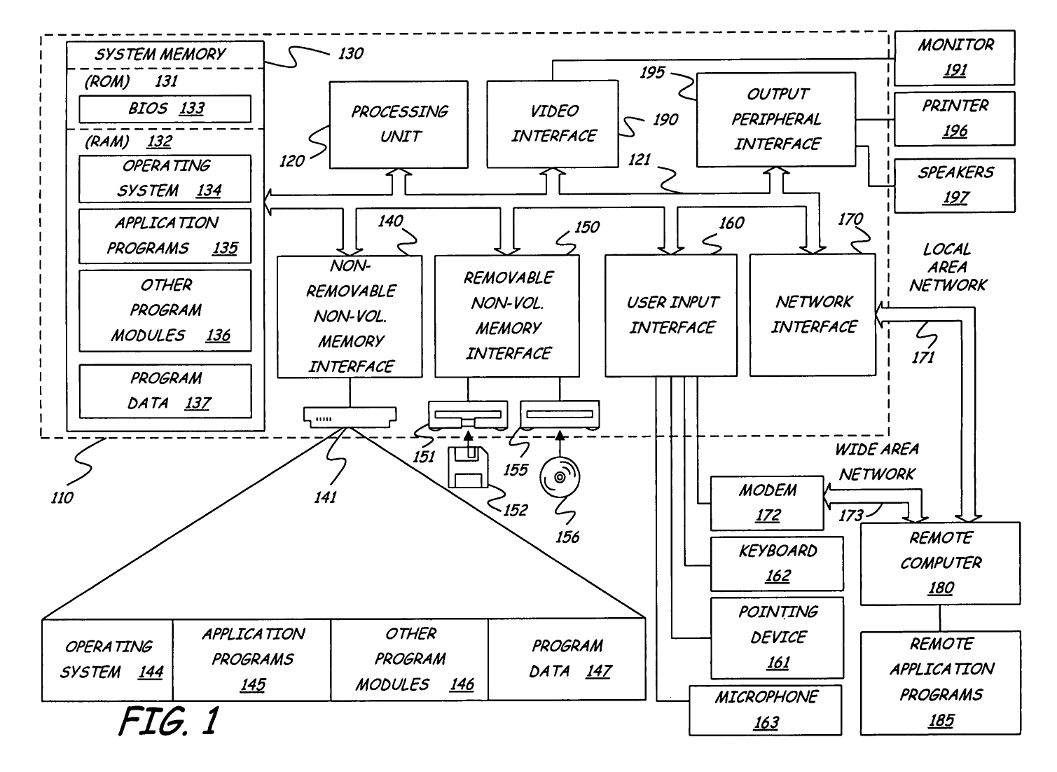

With reference to FIG. 1, an exemplary system includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PIT) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input de-vices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a locale area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the concepts herein described can be carried out on a computer system such as that described with respect to FIG. 1. However, other suitable systems include a server, a computer devoted to message handling, or on a distributed system in which different portions of the concepts are carried out on different parts of the distributed computing system.

As indicated above, one aspect includes a method to detect segmentation errors in an annotated corpus such as but not limited to Chinese in order to improve quality of the data therein. Using Chinese by way of example, a Chinese character string occurring more than once in a corpus may be assigned different segmentations. Those differences can be considered as segmentation inconsistencies. But in order to provide a clearer description of those segmentation differences a new term “segmentation variation” will be used to replace “segmentation inconsistency”, the former of which will be described in more detail below.

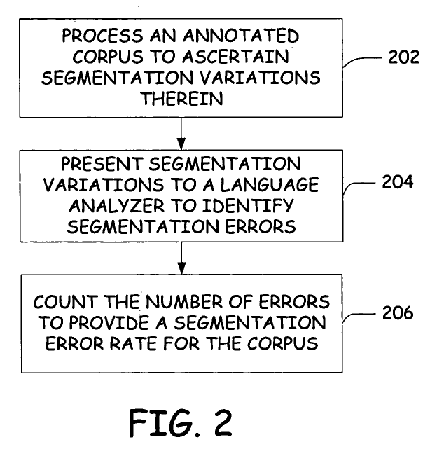

Referring to FIG. 2, a method 200 of detecting or spotting segmentation errors within an annotated corpus to provide an error rate includes steps of: (1) automatically processing with a computer an annotated corpus to ascertain segmentation variations therein at step 202, and (2) presenting the segmentation variations at step 204 using a computer to an language analyzer so as to identify segmentation errors within those candidates. At step 206, the number of errors ascertained in the corpus can then be counted, thereby giving the segmentation error rate (number of errors/number of segmentations in corpus) of the corpus, which is valuable information that has not otherwise been noted or recorded. (For completeness, performance of a word segmentation system is measured in terms of precision and recall, where precision=number of errors/number of words detected by the system, and recall=number of correctly detected by the system/number of words in a known (sometimes referred to as “golden”) test set.)

However, it has been discovered that most of segmentation inconsistencies found in an annotated corpus turned out to be correct segmentations of combination ambiguity strings (CAS). Therefore it is not an appropriate technique term to assess the quality of an annotated corpus. Besides, with the concept of “segmentation inconsistency” it is hard to distinguish the different inconsistent components within an annotated corpus and finally count up the number of segmentation errors exactly. Accordingly, a new term “segmentation variation” defined below will be used to replace “segmentation inconsistency”.

The following definitions define “segmentation variation”, “variation instance” and “error instance”(i.e. “segmentation error”).

Definition 1: In an annotated or presegmented corpus C (boundary annotations of the corpus C that separates out words), a set of f(W, C) is defined as: f(W, C)={all possible segmentations that word W has in corpus C}. Stated another way, each set f comprises different segmentations of the word W in the corpus C. For example, for a word W comprising “Feb. 17, 2005” present in corpus C, other segmentations in corpus C, and thus, in set f could be “February 17,” “2005” (i.e. two tokens), or “February”, “17,” “2005” (i.e. three tokens).

Definition 2 builds upon definition 1 and provides:

Definition 2: W is a “segmentation variation type” (“segmentation variation” in short and hereafter) with respect to C if and only if |f(W, C) |>1. Stated another way, if the size of the set f is greater than one, then the set f is called a “segmentation variation”.

Definition 3 builds upon definition 2 and provides:

Definition 3: An instance of a word in f(W, C) is called: a segmentation variation instance (“variation instance”). Thus a “segmentation variation” includes two or more “variation instances” in corpus C. Furthermore, each variation instance may include one or more than one token.

Definition 4 builds upon definition 3 and provides:

Definition 4: If a variation instance is an incorrect segmentation, it is called an “error instance”.

The existence of segmentation variations in a corpus is attributable to one of two reasons: 1) ambiguity: variation type W has multiple possible segmentations in different legitimate contexts, or 2) error: W has been wrongly segmented, which could be judged by a given lexicon or dictionary. The definitions of “segmentation variation”, “variation instance” and “error instance” clearly distinguish those inconsistent components, so a count of the number of segmentation errors can be made exactly.

It should be further noted, a segmentation—variation caused by ambiguity is called a “CAS variation” and a segmentation variation caused by is error is called a “non-CAS variation”. Each kind of segmentation variation may include error instances.

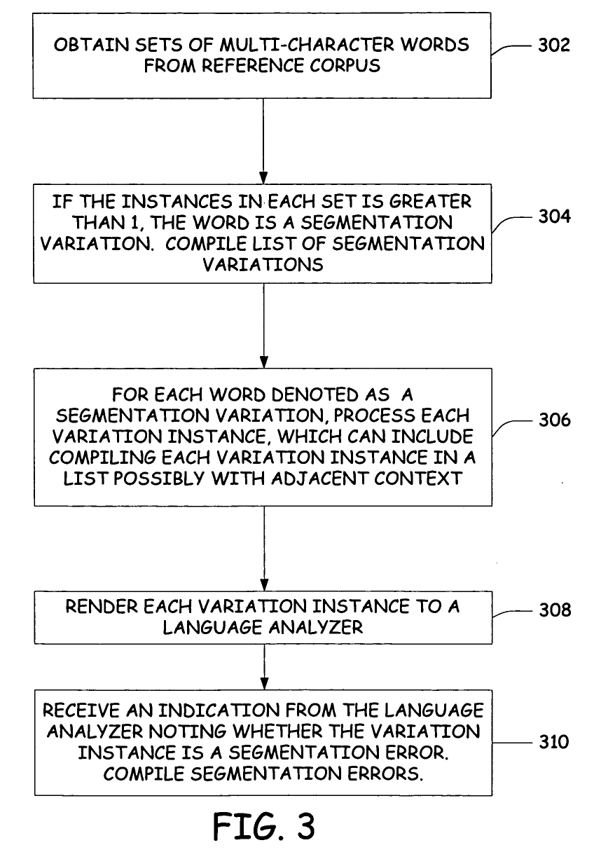

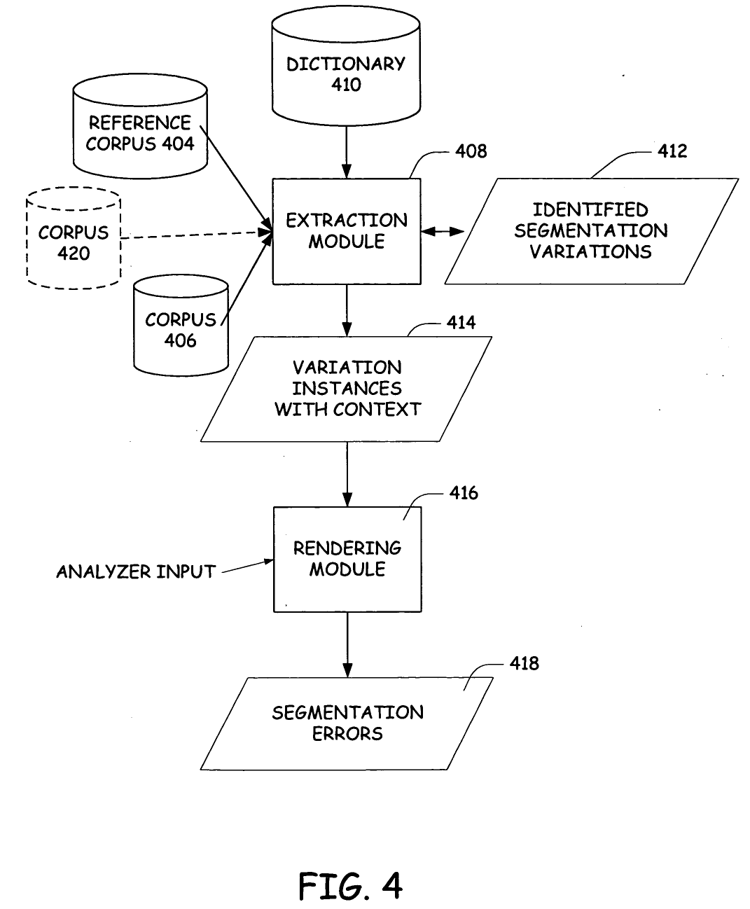

FIG. 3 illustrates a flow chart for performing a method 300 to find segmentation variations and processing the same, while FIG. 4 schematically illustrates a system 400 for performing method 300. As appreciated by those skilled in the art, system 300 can be implemented on computing environment 100 or other computing environments as discussed above. Furthermore, it should be noted that the modules present in system 400 are provided for purposes of understanding, wherein other modules can used to perform individual tasks, or combinations of tasks, described with respect to the tasks performed by the modules illustrated.

Generally, method 300 and system 400 can output a list 412 of segmentation variations, a list of segmentation instances 414 and segmentation errors 418 between the two corpora 404 and 406, or such lists of a single corpus 420.

As illustrated, method 300 can begin with step 302 where an extracting module 408 identifies or locates all the multi-character words in reference corpus 406 in sets f(W, C) according to Definition 1 above, even if a set only has one instance. This step can be accomplished by storing their respective positions in reference corpus 406. To perform this step, extracting module 408 can access a dictionary 410, where words found both in the reference corpus 404 and dictionary 410 are identified, while those words in reference corpus 406 not found in dictionary 410 are considered out-of-vocabulary (OOV) and are not processed further.

At this point, a further description of dictionary 410 may be helpful. Dictionary 410 can be considered as having two parts. The first part, which comprises a closed set, can be considered a list of commonly accepted words such as named entities. However, since many named entities such as dates, numbers, etc. are not part of a closed set, but rather an open set, a second part of dictionary 410 is a specification or guidelines defining these open set named entities, which can not be otherwise enumerated. The specific guideline included in dictionary 410 is not important and may vary depending on the segmentation system using such specifications. Exemplary guidelines include ER-99: 1999 Named Entity Recognition (ER) Task Definition, version 1.3 NIST (The National Institute of Standard of Technology), 1999; MET-2: Multi Lingual Entity Task (MET) Definition, NIST, 2000; and ACE (Automatic Content Extraction) EDT Task: EDT (Entity Detection and Tracking) and Metonymy Annotation Guidelines, Version 2, May 2003.

Step 304, herein also exemplified as being performed by extracting module 408, includes identifying segmentation variations as described above in Definition 2 if the corresponding set f(W, C) has more than one instance. List 412, represents compiling the segmentation variations whether; directly extracted or indirectly by simply noting their positions.

At step 306, extracting module 408 uses the list 412 and compiles each of the variation instances for each of the segmentation variations in list 412. In one embodiment, compiling can include direct extraction from each of the corpuses 404 and 406; commonly with the corresponding context surrounding each variation instance (or at least adjacent context), or indirectly by simply noting their respective positions in the corpus. List 414 represents the output of step 306.

At step 308, a rendering module 416 accesses list 414 and renders each of the variation instances to a language analyzer. The language analyzer determines whether the variation instance is proper or improper (i.e. a segmentation error as provided in Definition 4). The rendering module 416 receives the analyzer's determination and compiles information related to segmentation errors for each of the corpuses 404 and 406, which is represented in FIG. 4 as list 418. If desired, the rendering module 416 can calculate the segmentation error rate for the corpus as described above.

Method 300 and system 400 as described above is particularly suited for checking for inconsistencies between reference corpus 406 and a second corpus 408. For instance, reference corpus 406 can be training data for a segmentation system, while corpus 408 is test data for the segmentation system as described above in the Background section. In this manner, list 418 identifies character strings segmented inconsistently between test data and training data, which can be classified further as a word identified in training data that has been segmented into multiple words in corresponding test data, or a word identified in test data that has been segmented into multiple words in corresponding training data. If otherwise unknown or undetected these errors can propagate and be realized as false performance errors when a system is being evaluated.

Nevertheless, it should be understood that method 300 and the modules of system 400 can also be used to check for consistencies in a single corpus 420, if desired. For example, method 300 and the modules of system 400 can be used to identify character strings that have been segmented, or merely are present, inconsistently within the test data or training data separately.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method to obtain a segmentation error rate of an annotated corpus, the method comprising:
processing the annotated corpus with a computer to ascertain segmentation variations therein;
presenting segmentation variations to a language analyzer with the computer to identify segmentation errors in the segmentation variations; and
counting a number of segmentation errors and calculating a segmentation error rate for the corpus.

2. The computer-implemented method of claim 1 wherein presenting segmentation variations includes presenting segmentation variations with some adjacent context.

3. The computer-implemented method of claim 1 wherein calculating the segmentation error rate includes a calculation based on the number of errors counted and the number of segmentations in the corpus.

4. A computer-implemented method for locating segmentation errors in an annotated corpus, the method comprising:
obtaining sets of segmentation variation instances of multi-character words from the corpus with a computer, each set comprising more than one segmentation variation instance of a word in the corpus;
rendering each segmentation variation instance to a language analyzer with the computer to identify if the segmentation variation instance is a segmentation error; and
receiving an indication if the segmentation variation instance is a segmentation error.

5. The computer-implemented method of claim 1 wherein rendering segmentation variations includes presenting segmentation variations with some adjacent context.

6. The computer-implemented method of claim 1 wherein obtaining sets of segmentation variation instances comprises compiling a list of the words for each set in a list.

7. The computer-implemented method of claim 6 and further comprising compiling each of the segmentation variation instances in a list.

8. The computer-implemented method of claim 7 and further comprising compiling each of the segmentation errors in a list.

9. A system for locating segmentation errors in an annotated corpus, the system comprising:
an extracting module configured to extract segmentation variations from the corpus and compile a list of segmentation variations instances for each of the segmentation variations having two or more segmentation variations for a given word;
a rendering module configured to render each segmentation variation instance and receive an indication from an analyzer as to whether the segmentation variation instance is a segmentation error.

10. The system of claim 9 wherein the rendering module is configured to render each segmentation variation instance with adjacent context.

11. The system of claim 10 wherein the rendering module is configured to calculate a segmentation error rate for the corpus based on the segmentation errors identified.
